(19) United States
(12) Patent Application Publication
(10) Pub. No.: US 2008/0286648 A1
(43) Pub. Date: Nov. 20, 2008

(54) ELECTROLYTIC SOLUTION AND BATTERY

(75) Inventors: Masayuki Ihara, Fukushima (JP); Hiroyuki Yamaguchi, Fukushima (JP); Tadahiko Kubota, Kanagawa (JP)

Correspondence Address: BELL, BOYD & LLOYD, LLP, P. O. BOX 1135, CHICAGO, IL, 60690, US

(73) Assignee: Sony Corporation, Tokyo (JP)

(21) Appl. No.: 11/932,704

(22) Filed: Oct. 31, 2007

(30) Foreign Application Priority Data
Dec. 13, 2006 (JP) 2006-335588

(51) Int. Cl. H01M 6/04

(52) U.S. Cl. 429/188

(57) ABSTRACT

A battery capable of securing the cycle characteristics and the storage characteristics is provided. The battery includes a cathode, an anode, and an electrolytic solution. The electrolytic solution is impregnated in a separator provided between the cathode and the anode. The electrolytic solution contains a solvent, an electrolyte salt, and a sulfone compound having a given structure (sulfonic acid, carboxylic acid anhydride not having an aromatic ring). Compared to a case that an electrolytic solution does not contain the foregoing sulfone compound, the decomposition reaction of the electrolytic solution is prevented.

### CROSS REFERENCES TO RELATED APPLICATIONS

The present application claims priority to Japanese Patent Application JP 2006-335588 filed in the Japanese Patent Office on Dec. 13, 2006, the entire contents of which is being incorporated herein by reference.

### BACKGROUND

The present application relates to an electrolytic solution containing a solvent and an electrolyte salt and a battery using the electrolytic solution.

In recent years, portable electronic devices such as combination cameras (videotape recorder), mobile phones, and notebook personal computers have been widely used, and it is strongly demanded to reduce their size and weight and to achieve their long life. Accordingly, as a power source for the portable electronic devices, a battery, in particular a light-weight secondary batter capable of providing a high energy density has been developed.

In particular, a secondary battery using insertion and extraction of lithium for charge and discharge reaction (so-called lithium ion secondary battery) or a secondary battery using precipitation and dissolution of lithium (so-called lithium metal secondary battery) is extremely prospective, since such a lithium ion secondary battery or such a lithium metal secondary battery can provide a higher energy density compared to a lead battery and a nickel cadmium battery.

For the composition of the electrolytic solution used for the foregoing secondary battery, for the purpose of improving various performances, several techniques have been already proposed. More specifically, for improving the cycle characteristics, the storage characteristics and the like, the following technique has been known. In such a technique, an electrolytic solution contains a chain sulfone compound or a cyclic sulfone compound (for example, refer to Japanese Unexamined Patent Application Publication Nos. 2002-008718, 2002-313418, 2005-502179, and 2006-156331). As the cyclic sulfone compound, 2-sulfobenzoic anhydride or the like is used.

In the recent electronic devices, there is a tendency that the high performance and the multi-functions of the electronic devices are increasingly developed. Thus, there is a tendency that the cycle characteristics are easily lowered by frequently repeating charge and discharge of the secondary battery. Further, there is a tendency that the calorific value is more and more increased due to factors such as high performance of electronic parts typified by a CPU (central processing unit). Thus, the secondary battery is exposed in the high temperature atmosphere, and thereby the storage characteristics tend to be lowered. Therefore, it is aspired that the cycle characteristics and the storage characteristics of the secondary battery could be further improved.

### SUMMARY

In view of the foregoing, it is desirable to provide an electrolytic solution and a battery capable of securing the cycle characteristics and the storage characteristics.

According to an embodiment, there is provided an electrolytic solution including a solvent, an electrolyte salt, and a sulfone compound shown in Chemical formula 1.

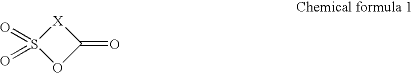

X represents an alkylene group with the carbon number in the range from 2 to 4, an alkenylene group with the carbon number in the range from 2 to 4, a derivative of alkylene group or a derivative of alkenylene group.

According to an embodiment, there is provided a battery including a cathode, an anode, and an electrolytic solution, wherein the electrolytic solution contains a solvent, an electrolyte salt, and a sulfone compound shown in Chemical formula 1.

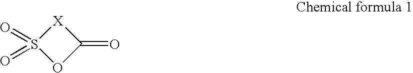

X represents an alkylene group with the carbon number in the range from 2 to 4, an alkenylene group with the carbon number in the range from 2 to 4, a derivative of alkylene group or a derivative of alkenylene group.

The electrolytic solution of the embodiment of the invention includes the sulfone compound shown in Chemical formula 1. Thus, compared to a case that an electrolytic solution does not contain such a sulfone compound, the decomposition reaction is prevented when the electrolytic solution is used for an electrochemical device such as a battery. Thereby, according to a battery using the electrolytic solution of the embodiment of the invention, the electrolytic solution becomes stable electrochemically, and thus the cycle characteristics and the storage characteristics can be secured. In this case, when the content of the sulfone compound in the electrolytic solution is in the range from 0.01 wt % to 5 wt %, higher effects can be obtained.

Additional features and advantages are described herein, and will be apparent from, the following Detailed Description and the figures.

### BRIEF DESCRIPTION OF THE FIGURES

FIG. 1 is a cross section showing a structure of a first battery using an electrolytic solution according to an embodiment;

FIG. 2 is a cross section showing an enlarged part of a spirally wound electrode body shown in FIG. 1;

FIG. 3 is an exploded perspective view showing a structure of a forth battery using the electrolytic solution according to the embodiment; and

FIG. 4 is a cross section showing a structure taken along line IV-IV of a spirally wound electrode body shown in FIG. 4.

### DETAILED DESCRIPTION

An embodiment will be hereinafter described in detail with reference to the drawings.

An electrolytic solution according to an embodiment is used for an electrochemical device such as a battery. The electrolytic solution according to the embodiment of the invention contains a solvent, an electrolyte salt, and the sulfone compound shown in Chemical formula 1. Since the electrolytic solution contains the sulfone compound, the decomposition reaction of the electrolytic solution is prevented, and thereby superior cycle characteristics and superior storage characteristics can be obtained in the electrochemical device including the electrolytic solution. The carbon number of X in Chemical formula 1 is in the range from 2 to 4. When the carbon number is 1, sufficient chemical stability is not able to be obtained. Meanwhile, when the carbon number is 5 or more, sufficient solubility is not able to be obtained. In particular, the content of the sulfone compound shown in Chemical formula 1 in the electrolytic solution is preferably in the range from 0.01 wt % to 5 wt %, since thereby higher effects can be obtained.

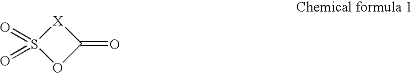

In the formula, X represents an alkylene group with the carbon number in the range from 2 to 4, an alkenylene group with the carbon number in the range from 2 to 4, or a derivative thereof.

As an example of the sulfone compound shown in Chemical formula 1, the compounds shown in Chemical formula 2 can be cited. One of the foregoing may be used singly, or two or more thereof may be used by mixing. It is needless to say that the sulfone compound is not limited to the foregoing compounds shown in Chemical formula 2, and the sulfone compound may be other compound as long as such a compound has the structure shown in Chemical formula 1.

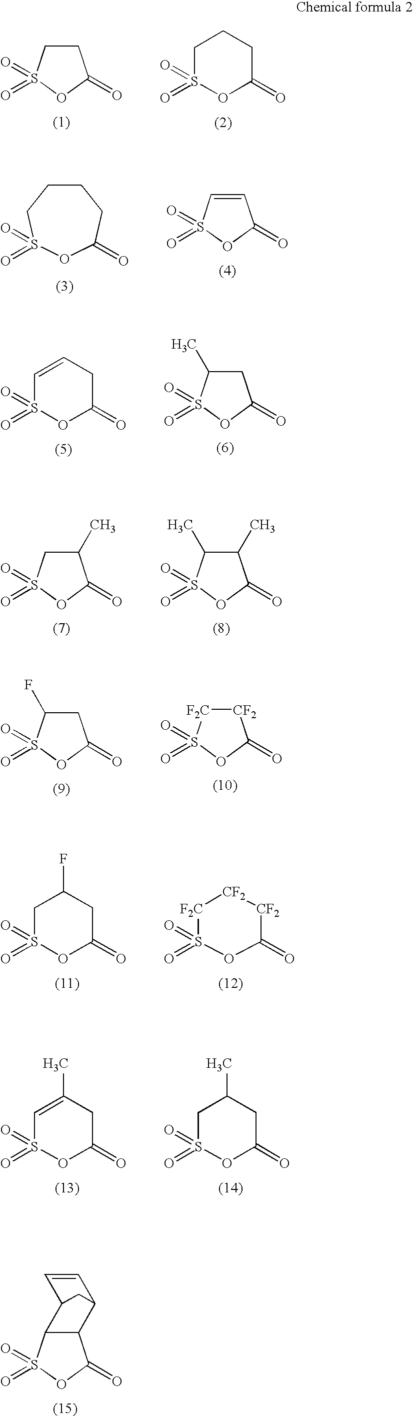

The solvent may contain, for example, a nonaqueous solvent such as an organic solvent. The nonaqueous solvents include, for example, ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, trimethyl methyl acetate, trimethyl ethyl acetate, acetonitrile, glutaronitrile, adiponitrile, methoxyacetonitrile, 3-methyoxypropionitrile, N,N-dimethylformamide, N-methylpyrrolidinone, N-methyloxazolidinone, N,N′-dimethylimidazolidinone, nitromethane, nitroethane, sulfolane, dimethyl sulfoxide phosphate and the like. Thereby, in the electrochemical device including the electrolytic solution, superior capacity characteristics, superior cycle characteristics, and superior storage characteristics are obtained. One thereof may be used singly, or two or more thereof may be used by mixing. Specially, the solvent preferably contains a mixture of a high-viscosity (high dielectric constant) solvent (for example, dielectric constant ∈□30) such as ethylene carbonate and propylene carbonate and a low-viscosity solvent (for example, viscosity□1 mPa□s) such as dimethyl carbonate, ethyl methyl carbonate, and diethyl carbonate. Thereby, the dissociation property of the electrolyte salt and the ion mobility are improved, and thus higher effects can be obtained.

In particular, the solvent preferably contains at least one selected from the group consisting of chain ester carbonate having a halogen as an element shown in Chemical formula 3 and cyclic ester carbonate having a halogen as an element shown in Chemical formula 4. Thereby, higher effects can be obtained.

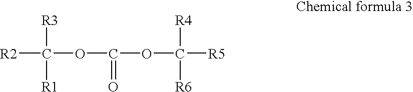

In the formula, R1 to R6 represent a hydrogen group, a halogen group, an alkyl group, or an alkyl halide group. R1 to R6 may be identical or different. However, at least one of R1 to R6 is the halogen group or the alkyl halide group.

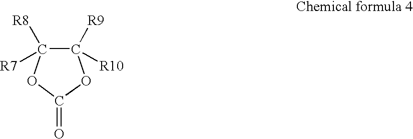

In the formula, R7 to R10 represent a hydrogen group, a halogen group, an alkyl group, or an alkyl halide group. R7 to R10 may be identical or different. However, at least one of R7 to R10 is the halogen group or the alkyl halide group.

The chain ester carbonate having a halogen as an element shown in Chemical formula 3 includes, for example, fluoromethyl methyl carbonate, bis(fluoromethyl) carbonate, difluoromethyl methyl carbonate and the like. One thereof may be used singly, or two or more thereof may be used by mixing.

The cyclic ester carbonate having a halogen as an element shown in Chemical formula 4 includes, for example, compounds shown in Chemical formula 5 and Chemical formula 6, that is, 4-fluoro-1,3-dioxolane-2-one in Chemical formula 5(1), 4-chloro-1,3-dioxolane-2-one in Chemical formula 5(2), 4,5-difluoro-1,3-dioxolane-2-one in Chemical formula 5(3), tetrafluoro-1,3-dioxolane-2-one in Chemical formula 5(4), 4-fluoro-5-chloro-1,3-dioxolane-2-one in Chemical formula 5(5), 4,5-dichloro-1,3-dioxolane-2-one in Chemical formula 5(6), tetrachloro-1,3-dioxolane-2-one in Chemical formula 5(7), 4,5-bistrifluoromethyl-1,3-dioxolane-2-one in Chemical formula 5(8), 4-trifluoromethyl-1,3-dioxolane-2-one in Chemical formula 5(9), 4,5-difluoro-4,5-dimethyl-1,3-dioxolane-2-one in Chemical formula 5(10), 4-methyl-5,5-difluoro-1,3-dioxolane-2-one in Chemical formula 5(11), 4-ethyl-5,5-difluoro-1,3-dioxolane-2-one in Chemical formula 5(12) and the like; and 4-trifluoromethyl-5-fluoro-1,3-dioxolane-2-one in Chemical formula 6(1), 4-trifluoromethyl-5-methyl-1,3-dioxolane-2-one in Chemical formula 6(2), 4-fluoro-4,5-dimethyl-1,3-dioxolane-2-one in Chemical formula 6(3), 4,4-difluoro-5-(1,1-difluoroethyl)-1,3-dioxolane-2-one in Chemical formula 6(4), 4,5-dichloro-4,5-dimethyl-1,3-dioxolane-2-one in Chemical formula 6(5), 4-ethyl-5-fluoro-1,3-dioxolane-2-one in Chemical formula 6(6), 4-ethyl-4,5-difluoro-1,3-dioxolane-2-one in Chemical formula 6(7), 4-ethyl-4,5,5-trifluoro-1,3-dioxolane-2-one in Chemical formula 6(8), 4-fluoro-4-methyl-1,3-dioxolane-2-one in Chemical formula 6(9) and the like. One thereof may be used singly, or two or more thereof may be used by mixing. Specially, as the cyclic ester carbonate having a halogen as an element, at least one selected from the group consisting of 4-fluoro-1,3-dioxolane-2-one and 4,5-difluoro-1,3-dioxolane-2-one is preferable, since these cyclic ester carbonates are easily available, and can provide sufficient effects. In particular, as 4,5-difluoro-1,3-dioxolane-2-one, a trans isomer is more preferable than a cis isomer to obtain higher effects.

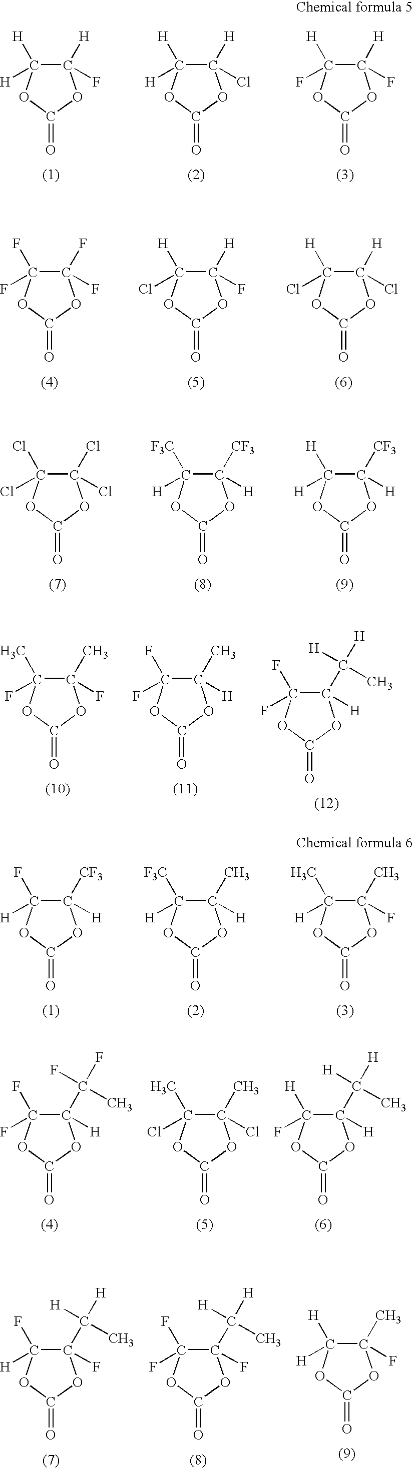

The solvent preferably contains, for example, cyclic ester carbonate having an unsaturated bond. Thereby, higher effects can be obtained. As the cyclic ester carbonate having an unsaturated bond, for example, vinylene carbonate, vinyl ethylene carbonate and the like can be cited. One thereof may be used singly, or two or more thereof may be used by mixing. Specially, as the cyclic ester carbonate having an unsaturated bond, vinylene carbonate is preferably contained, since thereby sufficient effects can be obtained. In particular, when the solvent contains the foregoing chain ester carbonate having a halogen as an element or the foregoing cyclic ester carbonate having a halogen as an element, and the solvent further contains the cyclic ester carbonate having an unsaturated bond, significantly high effects can be obtained.

The electrolyte salt contains, for example, a light metal salt such as a lithium salt. The lithium salt includes, for example, lithium hexafluorophosphate (LiPF6), lithium tetrafluoroborate (LiBF4), lithium perchlorate (LiClO4), lithium hexafluoroarsenate (LiAsF6), lithium tetraphenyl borate (LiB(C6H5)4), methane sulfonic lithium (LiCH3SO3), trifluoromethane sulfonic lithium (LiCF3SO3), lithium tetrachloroaluminate (LiAlCl4), lithium silicate hexafluoride (Li2SiF6), lithium chloride (LiCl), lithium bromide (LiBr) and the like. Such a lithium salt may be used singly, or two or more thereof may be used by mixing. Specially, the electrolyte salt preferably contains lithium hexafluorophosphate, since thereby the internal resistance is lowered, and thus superior capacity characteristics, superior cycle characteristics, and superior storage characteristics can be obtained in the electrochemical device including the electrolytic solution.

The electrolyte salt may contain the compounds shown in Chemical formulas 7 to 9. Thereby, sufficient effects can be obtained. One thereof may be used singly, or two or more thereof may be used by mixing.

LiN(CmF2m+1SO2)(CnF2n+1SO2) Chemical formula 7

In the formula, m and n represent an integer number of 1 or more. m and n may be identical or different.

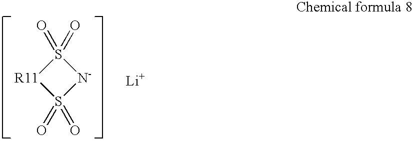

In the formula, R11 represents a straight chain or branched perfluoro alkylene group with the carbon number in the range from 2 to 4.

LiC(CpF2p+1SO2)(CqF2q+1SO2)(CrF2r+1SO2) Chemical formula 9

In the formula, p, q, and r represent an integer number of 1 or more. p, q, and r may be identical or different.

The chain compound shown in Chemical formula 7 includes, for example, lithium bis(trifluoromethanesulfonyl)imide (LiN(CF3SO2)2), lithium bis(pentafluoroethanesulfonyl)imide (LiN(C2F5SO2)2), lithium (trifluoromethanesulfonyl)(pentafluoroethanesulfonyl)imide (LiN(CF3SO2)(C2F5SO2)), lithium (trifluoromethanesulfonyl)(heptafluoropropanesulfonyl)imide (LiN(CF3SO2)(C3F7SO2)), lithium (trifluoromethanesulfonyl)(nonafluorobutanesulfonyl)imide (LiN(CF3 SO2)(C4F9SO2)) and the like.

The cyclic compounds shown in Chemical formula 8 include, for example, compounds shown in Chemical formula 10, that is, lithium 1,2-perfluoroethanedisulfonylimide in Chemical formula 10(1), lithium 1,3-perfluoropropanedisulfonylimide in Chemical formula 10(2), lithium 1,3-perfluorobutanedisulfonylimide in Chemical formula 10(3), lithium 1,4-perfluorobutanedisulfonylimide in Chemical formula 10(4) and the like. Specially, the electrolyte salt preferably contains lithium 1,3-perfluoropropanedisulfonylimide, since thereby sufficient effects can be obtained.

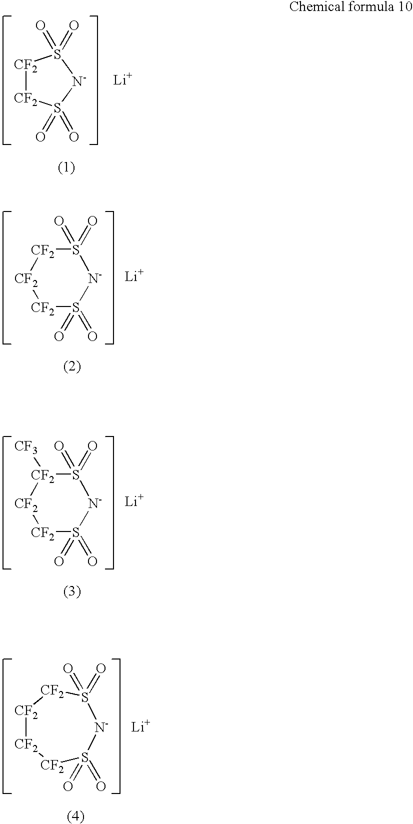

The chain compound shown in Chemical formula 9 includes, for example, lithium tris(trifluoromethanesulfonyl)methyde (LiC(CF3SO2)3) and the like.

The content of the electrolyte salt is preferably in the range from 0.3 mol/kg to 3.0 mol/kg to the solvent. If the content is out of the foregoing range, there is a possibility that the ion conductivity is significantly lowered and thus sufficient capacity characteristics and the like are not able to be obtained in the electrochemical device including the electrolytic solution.

The electrolytic solution contains the solvent, the electrolyte salt, and the sulfone compound shown in Chemical formula 1. Therefore, compared to a case in which the electrolytic solution does not contain the sulfone compound, the decomposition reaction is suppressed when the electrolytic solution is used for an electrochemical device such as a battery. The case in which the electrolytic solution does not contain the sulfone compound shown in Chemical formula 1 includes, for example, a case in which the electrolytic solution contains a sulfone compound having an aromatic ring as X in Chemical formula 1 such as the sulfone compound shown in Chemical formula 11. Thus, according to the electrolytic solution of this embodiment, in the electrochemical device using the electrolytic solution, the electrolytic solution becomes stable electrochemically, and thus the cycle characteristics and the storage characteristics are secured. In this case, when the content of the sulfone compound shown in Chemical 1 in the electrolytic solution is in the range from 0.01 wt % to 5 wt %, higher effects can be obtained.

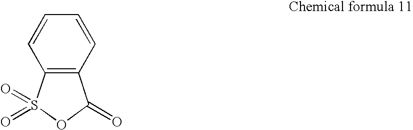

In particular, when the solvent contains the chain ester carbonate having a halogen as an element shown in Chemical formula 3 and the cyclic ester carbonate having a halogen as an element shown in Chemical formulas 4 to 6, or when the solvent contains the ester carbonate having an unsaturated bond, higher effects can be obtained.

Next, a description will be given of a usage example of the foregoing electrolytic solution. Taking a battery as an example of electrochemical devices, the electrolytic solution is used for the battery as follows.

First Battery

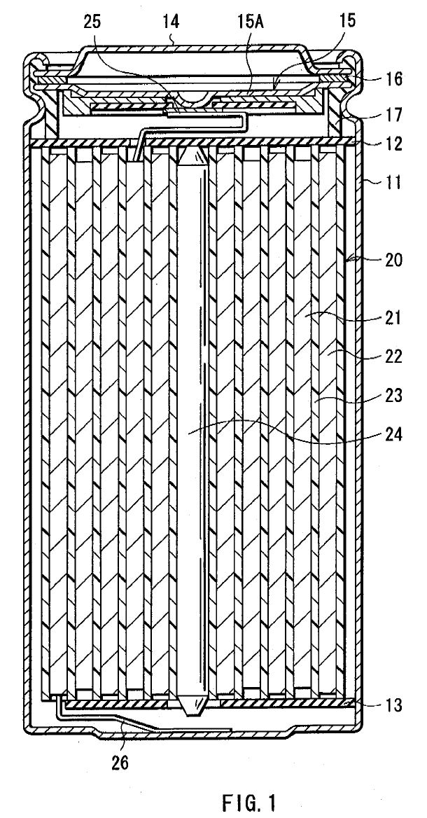

FIG. 1 shows a cross sectional structure of a first battery. The battery is a so-called lithium ion secondary battery in which the anode capacity is expressed by the capacity component based on insertion and extraction of lithium as an electrode reactant. FIG. 1 shows a battery structure of a so-called cylinder type secondary battery.

The secondary battery contains a spirally wound electrode body 20 in which a cathode 21 and an anode 22 are spirally wound with a separator 23 in between, and a pair of insulating plates 12 and 13 inside a battery can 11 in the shape of an approximately hollow cylinder. The battery can 11 is made of, for example, iron (Fe) plated by nickel (Ni). One end of the battery can 11 is closed, and the other end thereof is opened. The pair of insulating plates 12 and 13 is arranged to sandwich the spirally wound electrode body 20 in between and to extend perpendicularly to the spirally wound periphery face.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. In the safety valve mechanism 15, when the internal pressure of the battery becomes a certain level or more by internal short circuit, external heating or the like, a disk plate 15A flips to cut the electric connection between the battery cover 14 and the spirally wound electrode body 20. When temperature rises, the PTC device 16 increases the resistance and thereby limits a current to prevent abnormal heat generation resulting from a large current. The gasket 17 is made of, for example, an insulating material and its surface is coated with asphalt.

For example, a center pin 24 is inserted in the center of the spirally wound electrode body 20. In the spirally wound electrode body 20, a cathode lead 25 made of aluminum (Al) or the like is connected to the cathode 21, and an anode lead 26 made of nickel or the like is connected to the anode 22. The cathode lead 25 is electrically connected to the battery cover 14 by being welded to the safety valve mechanism 15. The anode lead 26 is welded and thereby electrically connected to the battery can 11.

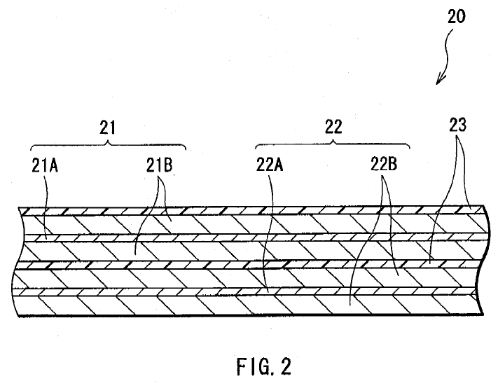

FIG. 2 shows an enlarged part of the spirally wound electrode body 20 shown in FIG. 1. The cathode 21 has a structure in which, for example, a cathode active material layer 21B is provided on the both faces of a cathode current collector 21A having a pair of opposed faces. The cathode current collector 21A is made of, for example, a metal material such as aluminum, nickel, and stainless. The cathode active material layer 21B contains, for example, as a cathode active material, one or more cathode materials capable of inserting and extracting lithium as an electrode reactant. If necessary, the cathode active material layer 21B may contain an electrical conductor, a binder and the like.

As the cathode material capable of inserting and extracting lithium, for example, a lithium complex oxide such as lithium cobalt oxide, lithium nickel oxide, a solid solution containing them (Li(NixCoyMnz)O2, values of x, y, and z are respectively expressed as 0<x<1, 0<y<1, 0<z<1, and x+y+z=1), lithium manganese oxide having a spinel structure (LiMn2O4), and a solid solution thereof (Li(Mn2-vNiv)O4, a value of v is expressed as v<2); or a phosphate compound having an olivine structure such as lithium iron phosphate (LiFePO4) is preferable. Thereby, a high energy density can be obtained. In addition, as the foregoing cathode material, for example, an oxide such as titanium oxide, vanadium oxide, and manganese dioxide; a disulfide such as iron disulfide, titanium disulfide, and molybdenum sulfide; sulfur; a conductive polymer such as polyaniline and polythiophene can be cited.

The anode 22 has a structure in which, for example, an anode active material layer 22B is provided on the both faces of an anode current collector 22A having a pair of opposed faces. The anode current collector 22A is made of, for example, a metal material such as copper (Cu), nickel, and stainless. The anode active material layer 22B contains, for example, as an anode active material, one or more anode materials capable of inserting and extracting lithium. If necessary, the anode active material layer 22B may contain an electrical conductor, a binder and the like.

As the anode material capable of inserting and extracting lithium, for example, a material that is capable of inserting and extracting lithium, and contains at least one of metal elements and metalloid elements as an element can be cited. Such an anode material is preferably used, since a high energy density can be thereby obtained. Such an anode material may be a simple substance, an alloy, or a compound of a metal element or a metalloid element, or may have one or more phases thereof at least in part. In the invention, alloys include an alloy containing one or more metal elements and one or more metalloid elements, in addition to an alloy including two or more metal elements. Further, an alloy in the invention may contain a nonmetallic element. The texture thereof includes a solid solution, a eutectic crystal (eutectic mixture), an intermetallic compound, and a texture in which two or more thereof coexist.

As such a metal element or such a metalloid element composing the anode material, for example, a metal element or a metalloid element capable of forming an alloy with lithium can be cited. Specifically, magnesium (Mg), boron (B), aluminum, gallium (Ga), indium (In), silicon, germanium (Ge), tin, lead (Pb), bismuth (Bi), cadmium (Cd), silver (Ag), zinc (Zn), hafnium (Hf), zirconium (Zr), yttrium (Y), palladium (Pd), platinum (Pt) and the like can be cited. Of the foregoing, at least one of silicon and tin is particularly preferable. Silicon and tin have the high ability to insert and extract lithium, and can provide a high energy density.

As an anode material containing at least one of silicon and tin, for example, the simple substance, an alloy, or a compound of silicon; the simple substance, an alloy, or a compound of tin; or a material having one or more phases thereof at least in part can be cited. One thereof may be used singly, or two or more thereof may be used by mixing.

As the alloy of silicon, for example, an alloy containing at least one selected from the group consisting of tin, nickel, copper, iron, cobalt (Co), manganese (Mn), zinc, indium, silver, titanium (Ti), germanium, bismuth, antimony (Sb), and chromium (Cr) as a second element other than silicon can be cited. As the alloy of tin, for example, an alloy containing at least one selected from the group consisting of silicon, nickel, copper, iron, cobalt, manganese, zinc, indium, silver, titanium, germanium, bismuth, antimony, and chromium as a second element other than tin can be cited.

As the compound of tin or the compound of silicon, for example, a compound containing oxygen (O) or carbon (C) can be cited. In addition to tin or silicon, the compound may contain the foregoing second element.

In particular, as the anode material containing at least one of silicon and tin, for example, an anode material containing a second element and a third element in addition to tin as a first element is preferable. It is needless to say that such an anode material may be used together with the above-mentioned anode material. As the second element, at least one selected from the group consisting of cobalt (Co), iron, magnesium, titanium (Ti), vanadium (V), chromium (Cr), manganese (Mn), nickel, copper, zinc, gallium, zirconium, niobium (Nb), molybdenum (Mo), silver, indium, cerium (Ce), hafnium, tantalum (Ta), tungsten (W), bismuth, and silicon is used. As the third element, at least one selected from the group consisting of boron, carbon (C), aluminum, and phosphorus (P) is used. When the second element and the third element are contained, the cycle characteristics are improved.

In particular, as an anode material, a CoSnC-containing material that contains tin, cobalt, and carbon as an element, in which the carbon content is in the range from 9.9 wt % to 29.7 wt %, and the cobalt ratio to the total of tin and cobalt (Co/(Sn+Co)) is in the range from 30 wt % to 70 wt % is preferable. In such a composition range, a high energy density can be obtained, and superior cycle characteristics can be obtained.

The CoSnC-containing material may further contain other element according to needs. As other element, for example, silicon, iron, nickel, chromium, indium, niobium, germanium, titanium, molybdenum, aluminum, phosphorus, gallium, bismuth or the like is preferable. Two or more thereof may be contained, since thereby the capacity characteristics or the cycle characteristics are further improved.

The CoSnC-containing material has a phase containing tin, cobalt, and carbon. Such a phase preferably has a low crystallinity structure or an amorphous structure. Further, in the CoSnC-containing material, at least part of carbon as an element is preferably bonded to a metal element or a metalloid element as other element. It is thought that lowering of cycle characteristics is caused by cohesion or crystallization of tin or the like. In this regard, when carbon is bonded to other element, such cohesion or crystallization can be prevented.

As a measurement method for examining bonding state of elements, for example, X-ray Photoelectron Spectroscopy (XPS) can be cited. In XPS, in the case of graphite, the peak of 1s orbit of carbon (C1s) is observed at 284.5 eV in the apparatus in which energy calibration is made so that the peak of 4f orbit of gold atom (Au4f) is obtained in 84.0 eV. In the case of surface contamination carbon, the peak is observed at 284.8 eV. Meanwhile, in the case of higher electric charge density of carbon element, for example, when carbon is bonded to a metal element or a metalloid element, the peak of C1s is observed in the region lower than 284.5 eV. That is, when the peak of the composite wave of C1s obtained for the CoSnC-containing material is observed in the region lower than 284.5 eV, at least part of carbon contained in the CoSnC-containing material is bonded to the metal element or the metalloid element as other element.

In XPS, for example, the peak of C1s is used for correcting the energy axis of spectrums. Since surface contamination carbon generally exists on the surface, the peak of C1s of the surface contamination carbon is set to in 284.8 eV, which is used as an energy reference. In XPS, the waveform of the peak of C1s is obtained as a form including the peak of the surface contamination carbon and the peak of carbon in the CoSnC-containing material. Therefore, for example, the waveform is analyzed by using commercially available software to separate the peak of the surface contamination carbon and the peak of carbon in the CoSnC-containing material. In the analysis of the waveform, the position of the main peak existing on the lowest bound energy side is set to the energy reference (284.8 eV).

As the anode material capable of inserting and extracting lithium, for example, a carbon material, a metal oxide, a polymer compound and the like can be cited. It is needless to say that such an anode material may be used together with the above-mentioned anode material. As the carbon material, for example, graphitizable carbon, non-graphitizable carbon in which the spacing of (002) plane is 0.37 nm or more, or graphite in which the spacing of (002) plane is 0.34 nm or less can be cited. More specifically, pyrolytic carbons, coke, graphite, glassy carbon, an organic polymer compound fired body, carbon fiber, activated carbon or the like can be cited. Of the foregoing, the coke includes pitch coke, needle coke, petroleum coke and the like. The organic polymer compound fired body is obtained by firing and carbonizing a polymer compound such as a phenol resin and a furan resin at an appropriate temperature. In the carbon material, a change in the crystal structure due to insertion and extraction of lithium is very little. Therefore, for example, by using the carbon material together with the above-mentioned anode material, a high energy density can be obtained and superior cycle characteristics can be obtained. In addition, the carbon material also functions as an electrical conductor, and thus the carbon material is preferably used. As the metal oxide, for example, iron oxide, ruthenium oxide, molybdenum oxide or the like can be cited. As the polymer compound, for example, polyacetylene, polypyrrole or the like can be cited.

As the electrical conductor, for example, a carbon material such as graphite, carbon black, and Ketjen black can be cited. Such a carbon material may be used singly, or two or more thereof may be used by mixing. The electrical conductor may be a metal material, a conductive polymer or the like as long as the material has the conductivity.

As the binder, for example, a synthetic rubber such as styrene-butadiene rubber, fluorinated rubber, and ethylene propylene diene; or a polymer material such as polyvinylidene fluoride can be cited. One thereof may be used singly, or two or more thereof may be used by mixing. However, when the cathode 21 and the anode 22 are spirally wound as shown in FIG. 1, flexible styrene-butadiene rubber, flexible fluorinated rubber or the like is preferably used.

In the secondary battery, by adjusting the amount of the cathode active material and the amount of the anode active material capable of inserting and extracting lithium, the charge capacity of the anode material capable of inserting and extracting lithium becomes larger than the charge capacity of the cathode active material, so that lithium metal is not precipitated on the anode 22 even when fully charged.

The separator 23 separates the cathode 21 from the anode 22, and passes lithium ions while preventing current short circuit due to contact of the both electrodes. The separator 23 is made of, for example, a porous film made of a synthetic resin such as polytetrafluoroethylene, polypropylene, and polyethylene, or a ceramic porous film. The separator 23 may have a structure in which two or more porous films as the foregoing porous films are layered. Specially, a polyolefin porous film is preferable since the polyolefin porous film has superior effects for preventing short circuit, and can contribute to improve battery safety by the shutdown effect. In particular, polyethylene is preferable since the shutdown effect can be obtained in the range from 100 deg C. to 160 deg C., and their electrochemical stability is superior. Polypropylene is also preferable. In addition, as long as a resin has the chemical stability, the resin may be used by being copolymerized or blended with polyethylene or polypropylene.

The foregoing electrolytic solution as a liquid electrolyte is impregnated in the separator 23. Thereby, superior cycle characteristics and the superior storage characteristics can be obtained.

The secondary battery can be manufactured, for example, as follows.

First, for example, the cathode 21 is formed by forming the cathode active material layer 21B on the both faces of the cathode current collector 21A. The cathode active material layer 21B is formed as follows. Cathode active material powder, an electrical conductor, and a binder are mixed to prepare a cathode mixture, which is dispersed in a solvent such as N-methyl-2-pyrrolidone to obtain paste cathode mixture slurry. Then, the cathode current collector 21A is coated with the cathode mixture slurry, which is dried, and the resultant is compression-molded. Further, for example, according to a procedure similar to that of the cathode 21, the anode 22 is formed by forming the anode active material layer 22B on the both faces of the anode current collector 22A.

Subsequently, the cathode lead 25 is attached to the cathode current collector 21A by being welded, and the anode lead 26 is attached to the anode current collector 22A by being welded. Subsequently, the cathode 21 and the anode 22 are spirally wound with the separator 23 in between, and thereby the spirally wound electrode body 20 is formed. The end of the cathode lead 25 is welded to the safety valve mechanism 15, and the end of the anode lead 26 is welded to the battery can 11. After that, the spirally wound electrode body 20 is sandwiched between the pair of insulating plates 12 and 13, and contained inside the battery can 11. Subsequently, the electrolytic solution is injected into the battery can 11 and impregnated in the separator 23. Finally, at the open end of the battery can 11, the battery cover 14, the safety valve mechanism 15, and the PTC device 16 are fixed by being caulked with the gasket 17. The secondary battery shown in FIG. 1 and FIG. 2 is thereby completed.

In the secondary battery, when charged, for example, lithium ions are extracted from the cathode 21 and inserted in the anode 22 through the electrolytic solution. Meanwhile, when discharged, for example, lithium ions are extracted from the anode 22, and inserted in the cathode 21 through the electrolytic solution.

According to the secondary battery, in the case that the capacity of the anode 22 is expressed by the capacity component based on insertion and extraction of lithium, the electrolytic solution contains the foregoing sulfone compound shown in Chemical formula 1. Thus, the cycle characteristics and the storage characteristics can be secured.

Next, a description will be given of a second battery and a third battery. For the elements common to those of the first battery, the same referential symbols are affixed thereto, and the description thereof will be omitted.

Second Battery

The second battery has a structure, operations, and effects similar to those of the first battery except that the anode 22 has a different structure, and is manufactured by a procedure similar to that of the first battery.

The anode 22 has a structure in which the anode active material layer 22B is provided on the both faces of the anode current collector 22A in the same manner as in the first battery. The anode active material layer 22B contains, for example, an anode active material containing silicon or tin as an element. Since silicon and tin have the high ability to insert and extract lithium, silicon and tin can provide a high energy density. In particular, silicon is preferable since its theoretical capacity is larger than that of tin. More specifically, for example, the anode active material layer 22B contains the simple substance, an alloy, or a compound of silicon, or the simple substance, an alloy, or a compound of tin. The anode active material layer 22B may contain two or more thereof.

The anode active material layer 22B is formed by using, for example, vapor-phase deposition method, liquid-phase deposition method, spraying method, firing method, or two or more of these methods. The anode active material layer 22B and the anode current collector 22A are preferably alloyed at the interface thereof at least in part. Specifically, it is preferable that at the interface thereof, the element of the anode current collector 22A is diffused in the anode active material layer 22B, or the element of the anode active material layer 22B is diffused in the anode current collector 22A, or both elements are diffused therein each other. Thereby, deconstruction due to expansion and shrinkage of the anode active material layer 22B caused by charge and discharge can be prevented, and electron conductivity between the anode active material layer 22B and the anode current collector 22A can be improved.

As vapor-phase deposition method, for example, physical deposition method or chemical deposition method can be cited. Specifically, vacuum vapor deposition method, sputtering method, ion plating method, laser ablation method, thermal CVD (Chemical Vapor Deposition) method, plasma CVD method and the like can be cited. As liquid-phase deposition method, a known technique such as electrolytic plating and electroless plating can be used. Firing method is, for example, a method in which a particulate anode active material, a binder and the like are mixed and dispersed in a solvent, and then the anode current collector 22A is coated with the mixture, and the resultant is heat-treated at a temperature higher than the melting point of the binder and the like. For firing method, a known technique such as atmosphere firing method, reactive firing method, and hot press firing method can be cited.

Third Battery

The third battery is a lithium metal secondary battery in which the capacity of the anode 22 is expressed by the capacity component based on precipitation and dissolution of lithium. The secondary battery has a structure similar to that of the first battery, except that the anode active material layer 22B is made of lithium metal, and is manufactured in the same manner as that of the first battery.

In the secondary battery, the lithium metal is used as an anode active material. Thereby, a high energy density can be obtained. The anode active material layer 22B may exist in assembling. Otherwise, it is possible that the anode active material layer 22B does not exist in assembling, and is made of the lithium metal precipitated in charging. Otherwise, by using the anode active material layer 22B as a current collector, the anode current collector 22A may be omitted.

In the secondary battery, when charged, for example, lithium ions are extracted from the cathode 21, and precipitated as the lithium metal on the surface of the anode current collector 22A through the electrolytic solution. Meanwhile, when discharged, for example, the lithium metal is eluted as lithium ions from the anode active material layer 22B, and the lithium ions are inserted in the cathode 21 through the electrolytic solution.

According to this secondary battery, in the case that the capacity of the anode is expressed by the capacity component based on precipitation and dissolution of lithium, the electrolytic solution contains the foregoing sulfone compound shown in Chemical formula 1. Therefore, the cycle characteristics and the storage characteristics can be secured.

Forth Battery

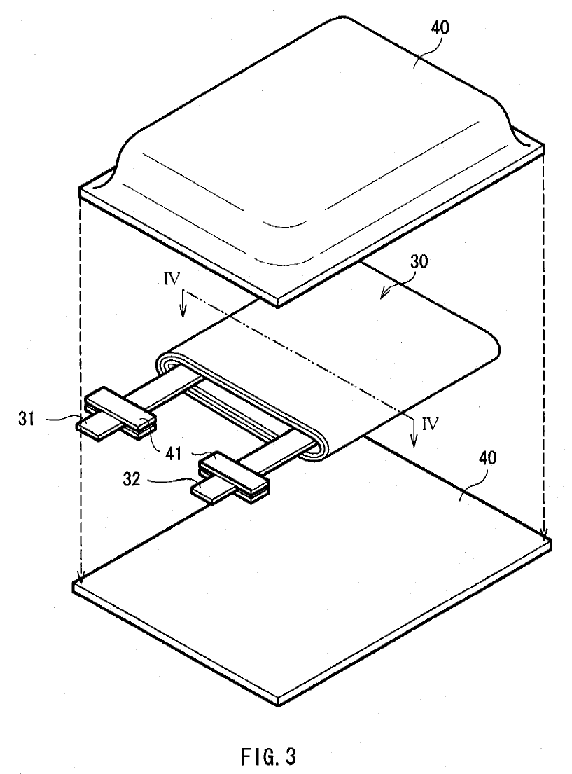

FIG. 3 shows an exploded perspective structure of a fourth battery. In the battery, a spirally wound electrode body 30 on which a cathode lead 31 and an anode lead 32 are attached is contained inside a film package member 40. The battery structure is a so-called laminated film type secondary battery.

The cathode lead 31 and the anode lead 32 are respectively directed from inside to outside of the package member 40 in the same direction, for example. The cathode lead 31 and the anode lead 32 are made of, for example, a metal material such as aluminum, copper, nickel, and stainless, and are in the shape of a thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film and the spirally wound electrode body 30 are opposed, and the respective outer edges are contacted to each other by fusion bonding or an adhesive. An adhesive film 41 to protect from entering of outside air is inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The package member 40 may be made of a laminated film having other structure, a polymer film such as polypropylene, or a metal film, instead of the foregoing three-layer aluminum laminated film.

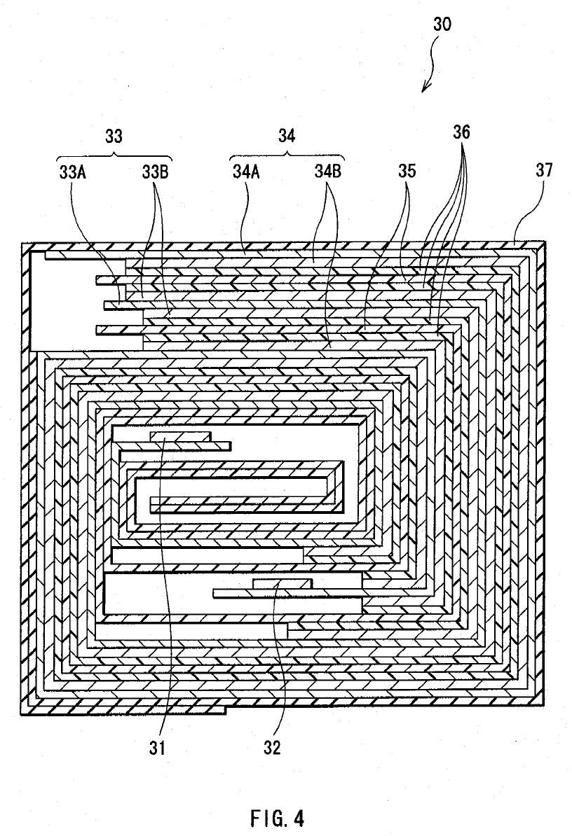

FIG. 4 shows a cross sectional structure taken along line IV-IV of the spirally wound electrode body 30 shown in FIG. 3. In the spirally wound electrode body 30, a cathode 33 and an anode 34 are layered with a separator 35 and an electrolyte 36 in between and then spirally wound. The outermost periphery thereof is protected by a protective tape 37.

The cathode 33 has a structure in which a cathode active material layer 33B is provided on the both faces of a cathode current collector 33A. The anode 34 has a structure in which an anode active material layer 34B is provided on the both faces of an anode current collector 34A. Arrangement is made so that the anode active material layer 34B faces the cathode active material layer 33B. The structures of the cathode current collector 33A, the cathode active material layer 33B, the anode current collector 34A, the anode active material layer 34B, and the separator 35 are similar to those of the cathode current collector 21A, the cathode active material layer 21B, the anode current collector 22A, the anode active material layer 22B, and the separator 23 of the foregoing first and second batteries.

The electrolyte 36 is so-called gelatinous, containing the foregoing electrolytic solution and a polymer compound that holds the electrolytic solution. The gel electrolyte is preferable, since high ion conductivity (for example, 1 mS/cm or more at room temperature) can be obtained and liquid leakage of the battery can be prevented.

As the polymer compound, for example, polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubber, nitrile-butadiene rubber, polystyrene, polycarbonate or the like can be cited. One of these polymer compounds may be used singly, or two or more thereof may be used by mixing. In particular, in terms of electrochemical stability, polyacrylonitrile, polyvinylidene fluoride, polyhexafluoropropylene, polyethylene oxide or the like is preferably used. The content of the polymer compound in the electrolytic solution varies according to the compatibility thereof, but for example, is preferably in the range from 5 wt % to 50 wt %.

The content of the electrolyte salt is similar to that of the above-mentioned electrolytic solution. However, in this case, the solvent means a wide concept including not only the liquid solvent but also a solvent having ion conductivity capable of dissociating the electrolyte salt. Therefore, when the polymer compound having ion conductivity is used, the polymer compound is also included in the solvent.

Instead of the electrolyte in which the electrolytic solution is held by the polymer compound (electrolyte 36), the electrolytic solution may be directly used. In this case, the electrolytic solution is impregnated in the separator 35.

The secondary battery is manufactured, for example, as follows.

First, a precursor solution containing the electrolytic solution, a polymer compound, and a mixed solvent is prepared. Then, the cathode 33 and the anode 34 are respectively coated with the precursor solution. After that, the mixed solvent is volatilized to form the electrolyte 36. Subsequently, the cathode lead 31 is attached to the cathode current collector 33A, and the anode lead 32 is attached to the anode current collector 34A. Subsequently, the cathode 33 and the anode 34 formed with the electrolyte 36 are layered with the separator 35 in between to obtain a lamination. After that, the lamination is spirally wound in the longitudinal direction, the protective tape 37 is adhered to the outermost periphery thereof to form the spirally wound electrode body 30. Subsequently, for example, the spirally wound electrode body 30 is sandwiched between the package members 40, and outer edges of the package members 40 are contacted by thermal fusion bonding or the like to enclose the spirally wound electrode body 30. Then, the adhesive film 41 is inserted between the cathode lead 31/the anode lead 32 and the package member 40. Thereby, the secondary battery shown in FIG. 3 and FIG. 4 is completed.

Otherwise, the secondary battery may be manufactured as follows. First, the cathode lead 31 and the anode lead 32 are respectively attached on the cathode 33 and the anode 34. After that, the cathode 33 and the anode 34 are layered with the separator 35 in between and spirally wound. The protective tape 37 is adhered to the outermost periphery thereof, and a spirally wound body as a precursor of the spirally wound electrode body 30 is formed. Subsequently, the spirally wound body is sandwiched between the package members 40, the peripheral edges other than one side are contacted by thermal fusion bonding or the like to obtain a pouched state, and the spirally wound body is contained inside the pouched-like package member 40. Subsequently, a composition of matter for electrolyte containing the electrolytic solution, a monomer as a raw material for a polymer compound, a polymerization initiator, and if necessary other material such as a polymerization inhibitor is prepared, which is injected into the pouched-like package member 40. After that, the opening of the package member 40 is hermetically sealed by, for example, thermal fusion bonding or the like. Finally, the monomer is thermally polymerized to obtain a polymer compound. Thereby, the gel electrolyte 36 is formed. Consequently, the secondary battery shown in FIG. 3 and FIG. 4 is completed.

The operations and the effects of the secondary battery are similar to those of the first or the second secondary battery described above.

### EXAMPLES

Specific examples of the invention will be described in detail.

1. Carbonaceous Anode

First, with the use of artificial graphite as an anode active material, the laminated film secondary battery shown in FIG. 3 and FIG. 4 was fabricated. The secondary battery was fabricated as a lithium ion secondary battery in which the capacity of the anode 34 was expressed by the capacity component based on insertion and extraction of lithium.

### Examples 1-1 to 1-4

First, the cathode 33 was formed. That is, lithium carbonate (Li2CO3) and cobalt carbonate (CoCO3) were mixed at a molar ratio of 0.5:1. After that, the mixture was fired in the air at 900 deg C. for 5 hours. Thereby, lithium cobalt complex oxide (LiCoO2) was obtained. Subsequently, 91 parts by weight of the lithium cobalt complex oxide as a cathode active material, 6 parts by weight of graphite as an electrical conductor, and 3 parts by weight of polyvinylidene fluoride (PVDF) as a binder were mixed to obtain a cathode mixture. After that, the cathode mixture was dispersed in N-methyl-2-pyrrolidone to obtain paste cathode mixture slurry. Finally, the both faces of the cathode current collector 33A made of a strip-shaped aluminum foil being 12 μm thick were uniformly coated with the cathode mixture slurry, which was dried. After that, the resultant was compression-molded by a roll pressing machine to form the cathode active material layer 33B. After that, the cathode lead 31 made of aluminum was welded to one end of the cathode current collector 33A.

Subsequently, the anode 34 was formed. That is, 90 parts by weight of artificial graphite powder as an anode active material and 10 parts by weight of PVDF as a binder were mixed to obtain an anode mixture. After that, the mixture was dispersed in N-methyl-2-pyrrolidone to obtain paste anode mixture slurry. Finally, the both faces of the anode current collector 34A made of a strip-shaped copper foil being 15 μm thick were uniformly coated with the anode mixture slurry, which was dried. After that, the resultant was compression-molded by a roll pressing machine to form the anode active material layer 34B. After that, the anode lead 32 made of nickel was welded to one end of the anode current collector 34A.

Subsequently, the cathode 33, the separator 35 made of a micro porous polypropylene film being 25 μm thick, and the anode 34 were layered in this order. After that, the resultant lamination was spirally wound many times in the longitudinal direction, the end portion of the spirally wound body was fixed by a protective tape 37 made of an adhesive tape, and thereby a spirally wound body as a precursor of the spirally wound electrode body 30 was formed. Subsequently, the spirally wound body was inserted between the package members 40 made of a laminated film having three-layer structure (total thickness: 100 μm) in which nylon being 30 μm thick, an aluminum foil being 40 μm thick, and non-stretched polypropylene being 30 μm thick were layered from the outside. After that, the outer edges other than the edge of one side of the package members 40 were thermally fusion-bonded to each other. Thereby, the spirally wound body was contained inside the package members 40 in a pouched state. Subsequently, the electrolytic solution was injected through the opening of the package member 40, the electrolytic solution was impregnated in the separator 35, and thereby the spirally wound electrode body 30 was formed.

As an electrolytic solution, an electrolytic solution containing a mixed solvent of ethylene carbonate (EC) and diethyl carbonate (DEC) as a solvent; lithium hexafluorophosphate (LiPF6) as an electrolyte salt; and the sulfone compound shown in Chemical formula 2(1) as the sulfone compound shown in Chemical formula 1 was used. The composition of the mixed solvent was EC:DEC=30:70 at a weight ratio. The concentration of LiPF6 in the electrolytic solution was 1 mol/kg. The content of the sulfone compound shown in Chemical formula 2(1) in the electrolytic solution was 0.01 wt % (Example 1-1), 1 wt % (Example 1-2), 2 wt % (Example 1-3), or 5 wt % (Example 1-4). “Wt %” means a value where the total of the solvent and the sulfone compound is 100 wt %. The meaning of “wt %” is similar to that in the following examples. Finally, the opening of the package member 40 was thermally fusion bonded and sealed in the vacuum atmosphere. Thereby, the laminated film type secondary battery was completed.

### Example 1-5

A procedure was performed in the same manner as that of Example 1-2, except that as the solvent, ethyl methyl carbonate (EMC) was used instead of DEC.

### Example 1-6

A procedure was performed in the same manner as that of Example 1-2, except that as a solvent, 4-fluoro-1,3-dioxolane-2-one (FEC) was used instead of EC.

### Example 1-7

A procedure was performed in the same manner as that of Example 1-2, except that propylene carbonate (PC) was added as a solvent. At that time, the composition of the mixed solvent was EC:DEC:PC=10:70:20 at a weight ratio.

### Example 1-8

A procedure was performed in the same manner as that of Example 1-2, except that 2 wt % of FEC was added as a solvent.

### Example 1-9

A procedure was performed in the same manner as that of Example 1-2, except that 2 wt % of trans-4,5-fluoro-1,3-dioxolane-2-one (trans-DFEC) was added as a solvent.

### Example 1-10

A procedure was performed in the same manner as that of Example 1-2, except that 2 wt % of vinylene carbonate (VC) was added as a solvent.

### Comparative Example 1-1

A procedure was performed in the same manner as that of Examples 1-1 to 1-4, except that the sulfone compound shown in Chemical formula 2(1) was not contained in the electrolytic solution.

### Comparative Example 1-2

A procedure was performed in the same manner as that of Example 1-2, except that the sulfone compound shown in chemical formula 11 was used instead of the sulfone compound shown in Chemical formula 2(1).

### Comparative Examples 1-3 and 1-4

A procedure was performed in the same manner as that of Examples 1-6 and 1-10, except that the sulfone compound shown in Chemical formula 2(1) was not contained in the electrolytic solution.

When the ambient temperature cycle characteristics and the high temperature storage characteristics of the secondary batteries of Examples 1-1 to 1-10 and Comparative examples 1-1 to 1-4 were examined, the results shown in Table 1 were obtained.

In examining the ambient temperature cycle characteristics, the secondary battery was repeatedly charged and discharged by the following procedure, and thereby the discharge capacity retention ratio was obtained. First, charge and discharge were performed 2 cycles in the atmosphere of 23 deg C., and thereby the discharge capacity at the second cycle was measured. Subsequently, the secondary battery was charged and discharged in the same atmosphere until the total of the number of cycles became 100 cycles, and thereby the discharge capacity at the 100th cycle was measured. Finally, the discharge capacity retention ratio (%)=(discharge capacity at the 100th cycle/discharge capacity at the second cycle)×100 was calculated. The charge and discharge condition of 1 cycle was as follows. That is, after constant current and constant voltage charge was performed at the charge current of 0.2 C until the upper limit voltage of 4.2 V, constant current discharge was performed at the discharge current of 0.2 C until the final voltage of 2.5 V. “0.2 C” means the current value at which the theoretical capacity is completely discharged in 5 hours.

In examining the high temperature storage characteristics, the secondary battery was stored at high temperature by the following procedure, and then the discharge capacity retention ratio was obtained. First, charge and discharge were performed 2 cycles in the atmosphere of 23 deg C., and thereby the discharge capacity at the second cycle (discharge capacity before being stored at high temperature) was obtained. Subsequently, the secondary battery was stored in a constant temperature bath at 80 deg C. for 10 days in a state of being charged again. After that, discharge was performed in the atmosphere of 23 deg C., and thereby the discharge capacity at the third cycle (discharge capacity after being stored at high temperature) was obtained. Finally, the discharge capacity retention ratio (%)=(discharge capacity after being stored at high temperatures/discharge capacity before being stored at high temperature)×100 was calculated. The charge and discharge condition of 1 cycle was similar to that of the case that the ambient temperature cycle characteristics were examined.

The foregoing procedures, conditions and the like in examining the ambient temperature cycle characteristics and the high temperature storage characteristics were similarly applied for evaluating the same characteristics of the following examples and comparative examples.

TABLE 1
Anode active material: artificial graphite

| | | | | | | Discharge capacity | |
|---|---|---|---|---|---|---|---|
| | | | | | | retention ratio (%) | |
| | | | | | | Ambient | High |
| | | | | | | temperature | temperature |
| | Electrolyte | | | Sulfone compound | | cycle | storage |
| | salt | Solvent | | Type | wt % | characteristics | characteristics |
| Example 1-1 | LiPF₆ | EC + DEC | — | Chemical | 0.01 | 89 | 86 |
| Example 1-2 | 1.0 mol/kg | | | formula 2(1) | 1 | 89 | 92 |
| Example 1-3 | | | | | 2 | 87 | 90 |
| Example 1-4 | | | | | 5 | 85 | 88 |
| Example 1-5 | | EC + EMC | | | 1 | 89 | 90 |
| Example 1-6 | | FEC + DEC | | | | 90 | 92 |
| Example 1-7 | | EC + DEC + PC | | | | 89 | 93 |
| Example 1-8 | | EC + DEC | FEC | | | 92 | 93 |
| | | | 2 wt % | | | | |
| Example 1-9 | | | Trans- | | | 94 | 92 |
| | | | DFEC | | | | |
| | | | 2 wt % | | | | |
| Example 1-10 | | | VC | | | 94 | 93 |
| | | | 2 wt % | | | | |
| Comparative | LiPF₆ | EC + DEC | — | — | — | 89 | 84 |
| example 1-1 | 1.0 mol/kg | | | | | | |
| Comparative | | | | Chemical | 1 | 89 | 86 |
| example 1-2 | | | | formula 11 | | | |
| Comparative | | FEC + DEC | | — | — | 89 | 85 |
| example 1-3 | | | | | | | |
| Comparative | | EC + DEC | VC | | | 90 | 85 |
| example 1-4 | | | 2 wt % | | | | |

As shown in Table 1, the discharge capacity retention ratio of the high temperature storage characteristics of Examples 1-1 to 1-4 in which the electrolytic solution contained the sulfone compound in Chemical formula 2(1) was higher than that of Comparative example 1-1 in which the electrolytic solution did not contain the sulfone compound in Chemical formula 2(1). Meanwhile, in terms of the content of the sulfone compound in Chemical formula 2(1), the discharge capacity retention ratio of the ambient temperature cycle characteristics of Examples 1-1 and 1-2 in which the content thereof was 1 wt % or less was equal to that of Comparative example 1-1, but the discharge capacity retention ratio of the ambient temperature cycle characteristics of Examples 1-3 and 1-4 in which the content thereof was 2 wt % or more was lower than that of Comparative example 1-1. However, in Examples 1-3 and 1-4, the discharge capacity retention ratio of the ambient temperature cycle characteristics reached 80%, that is, the sufficient discharge capacity retention ratio was obtained. The lower limit and the upper limit of the content of the sulfone compound in Chemical formula 2(1) in the case that the foregoing result was obtained in Examples 1-1 to 1-4 were respectively 0.01 wt % and 5 wt %. Accordingly, it was confirmed that in the secondary battery in which the anode 34 contained artificial graphite as the anode active material, when the electrolytic solution contained the sulfone compound shown in Chemical formula 1, the cycle characteristics and the storage characteristics were secured. It was also confirmed that in this case, the content of the sulfone compound shown in Chemical formula 1 in the electrolytic solution was preferably in the range from 0.01 wt % to 5 wt %.

Further, the discharge capacity retention ratio of the high temperature storage characteristics of Example 1-2 in which the electrolytic solution contained the sulfone compound in Chemical formula 2(1) was higher than that of Comparative example 1-2 in which the electrolytic solution contained the sulfone compound in Chemical formula 11. Meanwhile, the discharge capacity retention ratio of the ambient temperature cycle characteristics of Example 1-2 was equal to that of Comparative example 1-2. Accordingly, it was confirmed that in order to secure the cycle characteristics and the storage characteristics, the sulfone compound shown in Chemical formula 1 such as the sulfone compound in Chemical formula 2(1) was more preferable than the sulfone compound in Chemical formula 11 as a sulfone compound. Further, the discharge capacity retention ratio of the high temperature storage characteristics of Example 1-5 in which EMC was used instead of DEC as a solvent, Example 1-6 in which FEC was used instead of EC, and Example 1-7 in which PC was used in addition to EC and DEC was higher than that of Comparative example 1-1, and almost equal to that of Example 1-2. It is needless to say that in this case, the discharge capacity retention ratio of Example 1-6 was higher than that of Comparative example 1-3. Meanwhile, the discharge capacity retention ratio of the ambient temperature cycle characteristics of Examples 1-5 to 1-7 was equal to or higher than that of Comparative example 1-1, and almost equal to that of Example 1-2. In particular, out of Examples 1-5 to 1-7, the discharge capacity retention ratios of the ambient temperature cycle characteristics and the high temperature storage characteristics of Example 1-6 in which the solvent contained FEC were significantly high, that is, reached 90%. Accordingly, it was confirmed that in the secondary battery in which the electrolytic solution contained the sulfone compound shown in Chemical formula 1, even when the composition of the solvent was changed, the cycle characteristics and the storage characteristics were secured. It was also confirmed that in this case, when the solvent contained FEC, higher effects were obtained.

In addition, the discharge capacity retention ratio of the high temperature storage characteristics of Examples 1-8 to 1-10 in which FEC, trans-DFEC, or VC was respectively added to EC and DEC as a solvent was higher than that of Comparative example 1-1, and almost equal to or higher than that of Example 1-2. It is needless to say that in this case, the discharge capacity retention ratio of Example 1-10 was higher than that of Comparative example 1-4. Meanwhile, the discharge capacity retention ratio of the ambient temperature cycle characteristics of Examples 1-8 to 1-10 was higher than that of Comparative example 1-1 and Example 1-2. In particular, the discharge capacity retention ratios of the ambient temperature cycle characteristics and the high temperature storage characteristics of Examples 1-8 to 1-10 were significantly high, that is, reached 90%. Accordingly, it was confirmed that in the secondary battery in which the electrolytic solution contained the sulfone compound shown in Chemical formula 1, when the solvent contained the cyclic ester carbonate having a halogen as an element shown in Chemical formula 4 or the cyclic ester carbonate having an unsaturated bond, higher effects were obtained. No examples have been herein disclosed for a case that the solvent contained the chain ester carbonate having a halogen as an element shown in Chemical formula 3. However, in terms of preventing decomposition of the electrolytic solution, the chain ester carbonate having a halogen as an element shown in Chemical formula 3 has properties similar to those of the cyclic ester carbonate having a halogen as an element shown in Chemical formula 4. Therefore, it is evident that in the case using the chain ester carbonate having a halogen as an element shown in Chemical formula 3, the foregoing effects can be also obtained.

### Example 2-1

A procedure was performed in the same manner as that of Example 1-10, except that lithium tetrafluoroborate (LiBF4) was added as an electrolyte salt, and the concentration of LiPF6 in the electrolytic solution was 0.9 mol/kg, and the concentration of LiBF4 in the electrolytic solution was 0.1 mol/kg

### Example 2-2

A procedure was performed in the same manner as that of Example 2-1 except that lithium bis(trifluoromethanesulfonyl)imide (LiTFSI) was added instead of LiBF4 as an electrolyte salt.

### Example 2-3

A procedure was performed in the same manner as that of Example 2-1, except that lithium 1,3-perfluoropropanedisulfonylimide shown in Chemical formula 10(2) was added instead of LiBF4 as an electrolyte salt. For the secondary batteries of Examples 2-1 to 2-3, the ambient temperature cycle characteristics and the high temperature storage characteristics were examined. The results shown in Table 2 were obtained. Table 2 also shows the characteristics of Example 1-10 and Comparative example 1-4.

TABLE 2
Anode active material: artificial graphite

| | | | | | | | Discharge capacity | |
|---|---|---|---|---|---|---|---|---|
| | | | | | | | retention ratio (%) | |
| | | | | | | | | High |
| | | | | | Sulfone | | Ambient | temperature |
| | | | | | compound | | temperature cycle | storage |
| | Electrolyte salt | | Solvent | | Type | wt % | characteristics | characteristics |
| Example 1-10 | LiPF₆ | | EC + DEC | VC | Chemical | 1 | 94 | 93 |
| | 1.0 mol/kg | | | 2 wt % | formula | | | |
| Example 2-1 | LiPF₆ | LiBF₄ | | | 2(1) | | 89 | 92 |
| | 0.9 mol/kg | 0.1 mol/kg | | | | | | |
| Example 2-2 | | LiTFSI | | | | | 89 | 92 |
| | | 0.1 mol/kg | | | | | | |
| Example 2-3 | | Chemical | | | | | 90 | 94 |
| | | formula 10(2) | | | | | | |
| | | 0.1 mol/kg | | | | | | |

| | | | | | | | |
|---|---|---|---|---|---|---|---|
| Comparative | LiPF₆ | EC + DEC | VC | — | — | 90 | 85 |
| example 1-4 | 1.0 mol/kg | | 2 wt % | | | | |

As shown in Table 2, the discharge capacity retention ratio of the high temperature storage characteristics of Examples 2-1 to 2-3 in which the electrolytic solution contained the sulfone compound in Chemical formula 2(1) was higher than that of Comparative example 1-4 in which the electrolytic solution did not contain the sulfone compound in Chemical formula 2(1), and was almost equal to that of Example 1-10. Meanwhile, focusing attention on the type of the added electrolyte salt, the discharge capacity retention ratio of the ambient temperature cycle characteristics of Example 2-3 in which lithium 1,3-perfluoropropanedisulfonylimide was added was equal to that of Comparative example 1-4, but the discharge capacity retention ratio of the ambient temperature cycle characteristics of Examples 2-1 and 2-2 in which LiBF₄ and LiTFSI were respectively added was lower than that of Comparative example 1-1. The discharge capacity retention ratio of the ambient temperature cycle characteristics of Examples 2-1 to 2-3 was lower than that of Example 1-10, regardless of the type of the added electrolyte salt. However, the discharge capacity retention ratio of the ambient temperature cycle characteristics of Examples 2-1 to 2-3 reached 80%, and a sufficient discharge capacity retention ratio was obtained. Accordingly, it was confirmed that in the secondary battery in which the anode 34 contained the artificial graphite as the anode active material and the electrolytic solution contained the sulfone compound shown in Chemical formula 1, the cycle characteristics and the storage characteristics were secured even when the composition of the electrolyte salt was changed.

2. Metalloid Anode

Next, by using silicon as the anode active material, the laminated film type secondary battery shown in FIG. 3 and FIG. 4 was fabricated.

### Examples 3-1 to 3-7

A procedure was performed in the same manner as that of Examples 1-1 to 1-7, except that the anode active material layer 34B made of silicon was formed on the both faces of the anode current collector 34A by electron beam evaporation method.

### Examples 3-8 to 3-10

A procedure was performed in the same manner as that of Example 3-2, except that as a solvent, 5 wt % of FEC, trans-DFEC, or cis-DFEC was respectively added.

### Example 3-11

A procedure was performed in the same manner as that of Example 3-2, except that as a solvent, 2 wt % of VC was added.

### Example 3-12

A procedure was performed in the same manner as that of Example 3-2, except that as the sulfone compound shown in Chemical formula 1, the sulfone compound in Chemical formula 2(2) was used instead of the sulfone compound in Chemical formula 2(1).

### Comparative Example 3-1

A procedure was performed in the same manner as that of Examples 3-1 to 3-4, except that the sulfone compound in Chemical formula 2(1) was not contained in the electrolytic solution.

### Comparative Example 3-2

A procedure was performed in the same manner as that of Example 3-2, except that the sulfone compound in Chemical formula 11 was used instead of the sulfone compound in Chemical formula 2(1).

### Comparative Examples 3-3 and 3-4

A procedure was performed in the same manner as that of Examples 3-6 and 3-11, except that the sulfone compound in Chemical formula 2(1) was not contained in the electrolytic solution.

For the secondary batteries of Examples 3-1 to 3-12 and Comparative examples 3-1 to 3-4, the ambient temperature cycle characteristics and the high temperature storage characteristics were examined. The results shown in Table 3 were obtained.

TABLE 3
Anode active material: Si (electron beam evaporation method)

| | | | | | | Discharge capacity | |
|---|---|---|---|---|---|---|---|
| | | | | | | retention ratio (%) | |
| | | | | | | | High |
| | | | | | | Ambient | temperature |
| | Electrolyte | | | Sulfone compound | | temperature cycle | storage |
| | salt | Solvent | | Type | wt % | characteristics | characteristics |
| Example 3-1 | LiPF₆ | EC + DEC | — | Chemical | 0.01 | 55 | 80 |
| Example 3-2 | 1.0 mol/kg | | | formula | 1 | 60 | 84 |
| Example 3-3 | | | | 2(1) | 2 | 62 | 86 |
| Example 3-4 | | | | | 5 | 56 | 86 |
| Example 3-5 | | EC + EMC | | | 1 | 58 | 83 |
| Example 3-6 | | FEC + DEC | | | | 82 | 86 |
| Example 3-7 | | EC + DEC + PC | | | | 60 | 85 |
| Example 3-8 | | EC + DEC | FEC | | | 72 | 85 |
| | | | 5 wt % | | | | |
| Example 3-9 | | | Trans- | | | 85 | 88 |
| | | | DFEC | | | | |
| | | | 5 wt % | | | | |
| Example 3-10 | | | Cis-DFEC | | | 84 | 88 |
| | | | 5 wt % | | | | |
| Example 3-11 | | | VC | | | 72 | 85 |
| | | | 2 wt % | | | | |
| Example 3-12 | | | — | Chemical | 1 | 60 | 85 |
| | | | | formula | | | |
| | | | | 2(2) | | | |
| Comparative | LiPF₆ | EC + DEC | — | — | — | 52 | 74 |
| example 3-1 | 1.0 mol/kg | | | | | | |
| Comparative | | | | Chemical | 1 | 56 | 80 |
| example 3-2 | | | | formula 11 | | | |
| Comparative | | FEC + DEC | | — | — | 80 | 78 |
| example 3-3 | | | | | | | |
| Comparative | | EC + DEC | VC | | | 70 | 76 |
| example 3-4 | | | 2 wt % | | | | |

As shown in Table 3, the discharge capacity retention ratios of the ambient temperature cycle characteristics and the high temperature storage characteristics of Examples 3-1 to 3-4 in which the electrolytic solution contained the sulfone compound in Chemical formula 2(1) were higher than those of Comparative example 3-1 in which the electrolytic solution did not contain the sulfone compound in Chemical formula 2(1). The lower limit and the upper limit of the content of the sulfone compound in Chemical formula 2(1) in the case that the foregoing result was obtained in Examples 3-1 to 3-4 were respectively 0.01 wt % and 5 wt %. Accordingly, it was confirmed that in the secondary battery in which the anode 34 contained silicon (electron beam evaporation method) as the anode active material, when the electrolytic solution contained the sulfone compound shown in Chemical formula 1, the cycle characteristics and the storage characteristics were secured. It was also confirmed that in this case, the content of the sulfone compound shown in Chemical formula 1 in the electrolytic solution was preferably in the range from 0.01 wt % to 5 wt %.

Further, the discharge capacity retention ratio of the high temperature storage characteristics of Example 3-2 in which the electrolytic solution contained the sulfone compound in Chemical formula 2(1) was higher than that of Comparative example 3-2 in which the electrolytic solution contained the sulfone compound in Chemical formula 11. The discharge capacity retention ratio of the high temperature storage characteristics of Example 3-12 in which the electrolytic solution contained the sulfone compound in Chemical formula 2(2) was higher than that of Example 3-2 in which the electrolytic solution contained the sulfone compound in Chemical formula 2(1). Meanwhile, the discharge capacity retention ratio of the ambient temperature cycle characteristics of Examples 3-2 and 3-12 was higher than that of Comparative example 3-2. The discharge capacity retention ratio of the ambient temperature cycle characteristics of Examples 3-2 and 3-12 was equal to each other. Accordingly, it was confirmed that in order to secure the cycle characteristics and the storage characteristics, the sulfone compound shown in Chemical formula 1 such as the sulfone compound in Chemical formula 2(1) and the sulfone compound in Chemical formula 2(2) was more preferable than the sulfone compound in Chemical formula 11 as a sulfone compound.

Further, the discharge capacity retention ratios of the ambient temperature cycle characteristics and the high temperature storage characteristics of Example 3-5 in which EMC was used instead of DEC as a solvent, Example 3-6 in which FEC was used instead of EC, and Example 3-7 in which PC was used in addition to EC and DEC was higher than that of Comparative example 3-1, and almost equal to that of Example 3-2. It is needless to say that in this case, the discharge capacity retention ratio of Example 3-6 was higher than that of Comparative example 3-3. In particular, out of Examples 3-5 to 3-7, the discharge capacity retention ratios of the ambient temperature cycle characteristics and the high temperature storage characteristics of Example 3-6 in which the solvent contained FEC were significantly high. Accordingly, it was confirmed that in the secondary battery in which the electrolytic solution contained the sulfone compound shown in Chemical formula 1, even when the composition of the solvent was changed, the cycle characteristics and the storage characteristics were secured. It was also confirmed that in this case, when the solvent contained FEC, higher effects were obtained.

In addition, the discharge capacity retention ratios of the ambient temperature cycle characteristics and the high temperature storage characteristics of Examples 3-8 to 3-11 in which FEC, trans-DFEC, cis-DFEC, or VC was respectively added to EC and DEC as a solvent were higher than those of Comparative example 3-1 and Example 3-2. It is needless to say that in this case, the discharge capacity retention ratio of Example 3-11 was higher than that of Comparative example 3-4. In particular, out of Examples 3-8 to 3-11, the discharge capacity retention ratios of the ambient temperature cycle characteristics and the high temperature storage characteristics of Examples 3-9 and 3-10 in which the solvent contained trans-DFEC and cis-DFEC were significantly high. Accordingly, it was confirmed that in the secondary battery in which the electrolytic solution contained the sulfone compound shown in Chemical formula 1, when the solvent contained the cyclic ester carbonate having a halogen as an element shown in Chemical formula 1 or the cyclic ester carbonate having an unsaturated bond, higher effects were obtained. In addition, it was also confirmed that in the secondary battery in which the electrolytic solution contained the sulfone compound shown in Chemical formula 1, when the solvent contained DFEC, still higher effects were obtained.

### Examples 4-1 to 4-3

A procedure was performed in the same manner as that of Examples 2-1 to 2-3, except that the anode active material layer 34B was formed by the procedure described in Examples 3-1 to 3-12.

For the secondary batteries of Examples 4-1 to 4-3, the ambient temperature cycle characteristics and the high temperature storage characteristics were examined. The results shown in Table 4 were obtained. Table 4 also shows the characteristics of Example 3-9.

TABLE 4
Anode active material: Si (electron beam evaporation method)

| | | | | | | | Discharge capacity | |
|---|---|---|---|---|---|---|---|---|
| | | | | | | | retention ratio (%) | |
| | | | | | | | Ambient | High |
| | | | | | Sulfone | | temperature | temperature |
| | | | | | compound | | cycle | storage |
| | Electrolyte salt | | Solvent | | Type | wt % | characteristics | characteristics |
| Example 3-9 | LiPF₆ | | EC + DEC | Trans- | Chemical | 1 | 85 | 88 |
| | 1.0 mol/kg | | | DFEC | formula | | | |
| Example 4-1 | LiPF₆ | LiBF₄ | | 5 wt % | 2(1) | | 85 | 90 |
| | 0.9 mol/kg | 0.1 mol/kg | | | | | | |
| Example 4-2 | | LiTFSI | | | | | 85 | 89 |
| | | 0.1 mol/kg | | | | | | |
| Example 4-3 | | Chemical | | | | | 85 | 90 |
| | | formula 10(2) | | | | | | |
| | | 0.1 mol/kg | | | | | | |

As shown in Table 4, when comparison was made between Example 3-9 and Examples 4-1 to 4-3 in which the electrolytic solution contained the sulfone compound in Chemical formula 2(1) commonly, the discharge capacity retention ratios of the ambient temperature cycle characteristics and the high temperature storage characteristics of Examples 4-1 to 4-3 were almost equal to those of Example 3-9 regardless of the type of the added electrolyte salt. Accordingly, it was confirmed that in the secondary battery in which the anode 34 contained silicon (electron beam evaporation method) as the anode active material and the electrolytic solution contained the sulfone compound shown in Chemical formula 1, the cycle characteristics and the storage characteristics were secured even when the composition of the electrolyte salt was changed.

### Examples 5-1 to 5-12

A procedure was performed in the same manner as that of Examples 3-1 to 3-12, except that the anode 34 was formed by using sintering method. The anode 34 was formed as follows. First, 90 parts by weight of silicon powder with the average particle diameter of 2 μm as an anode active material and 10 wt % of polyvinylidene fluoride as a binder were mixed to obtain a mixture. After that, the mixture was dispersed in N-methyl-2-pyrrolidone to obtain mixture slurry. The both faces of the anode current collector 34A made of a copper foil being 20 μm thick were uniformly coated with the mixture slurry, which was dried. Subsequently, the resultant was compression-molded so that the thickness of a single face of the anode active material layer 34B became 15 μm. Finally, the resultant was heated for 3 hours at 350 deg C. and then cooled. After that, the resultant was cut in the shape of a strip.

### Comparative examples 5-1 to 5-4

A procedure was performed in the same manner as that of Comparative examples 3-1 to 3-4, except that the anode active material layer 34B containing silicon was formed on the both faces of the anode current collector 34A by sintering method in the same manner as that of Examples 5-1 to 5-12.

For the secondary batteries of Examples 5-1 to 5-12 and Comparative examples 5-1 to 5-4, the ambient temperature cycle characteristics and the high temperature storage characteristics were examined. The results shown in Table 5 were obtained.

TABLE 5
Anode active material: Si (sintering method)

| | | | | | | Discharge capacity | |
|---|---|---|---|---|---|---|---|
| | | | | | | retention ratio (%) | |
| | | | | | | | High |
| | | | | | | Ambient | temperature |
| | Electrolyte | | | Sulfone compound | | temperature cycle | storage |
| | salt | Solvent | | Type | wt % | characteristics | characteristics |
| Example 5-1 | LiPF₆ | EC + DEC | — | Chemical | 0.01 | 48 | 80 |
| Example 5-2 | 1.0 mol/kg | | | formula | 1 | 54 | 84 |
| Example 5-3 | | | | 2(1) | 2 | 58 | 86 |
| Example 5-4 | | | | | 5 | 50 | 86 |
| Example 5-5 | | EC + EMC | | | | 53 | 83 |
| Example 5-6 | | FEC + DEC | | | | 77 | 86 |
| Example 5-7 | | EC + DEC + PC | | | | 52 | 85 |
| Example 5-8 | | EC + DEC | FEC | | | 68 | 85 |
| | | | 5 wt % | | | | |
| Example 5-9 | | | Trans- | | | 82 | 88 |
| | | | DFEC | | | | |
| | | | 5 wt % | | | | |
| Example 5-10 | | | Cis-DFEC | | | 80 | 88 |
| | | | 5 wt % | | | | |
| Example 5-11 | | | VC | | | 67 | 85 |
| | | | 2 wt % | | | | |
| Example 5-12 | | | — | Chemical | 1 | 54 | 86 |
| | | | | formula | | | |
| | | | | 2(2) | | | |
| Comparative | LiPF₆ | EC + DEC | — | — | — | 45 | 75 |
| example 5-1 | 1.0 mol/kg | | | | | | |
| Comparative | | | | Chemical | 1 | 50 | 80 |
| example 5-2 | | | | formula 11 | | | |
| Comparative | | FEC + DEC | | — | — | 76 | 79 |
| example 5-3 | | | | | | | |
| Comparative | | EC + DEC | VC | | | 64 | 77 |
| example 5-4 | | | 2 wt % | | | | |

As shown in Table 5, the discharge capacity retention ratios of the ambient temperature cycle characteristics and the high temperature storage characteristics of Examples 5-1 to 5-4 were higher than that of Comparative example 5-1. The lower limit and the upper limit of the content of the sulfone compound in Chemical formula 2(1) in the case that the foregoing result was obtained in Examples 5-1 to 5-4 were respectively 0.01 wt % and 5 wt %. Accordingly, it was confirmed that in the secondary battery in which the anode 34 contained silicon (sintering method) as the anode active material, when the electrolytic solution contained the sulfone compound shown in Chemical formula 1, the cycle characteristics and the storage characteristics were secured. It was also confirmed that in this case, the content of the sulfone compound shown in Chemical formula 1 in the electrolytic solution was preferably in the range from 0.01 wt % to 5 wt %.

Further, the discharge capacity retention ratio of the high temperature storage characteristics of Example 5-2 was higher than that of Comparative example 5-2. The discharge capacity retention ratio of the high temperature storage characteristics of Example 5-12 was higher than that of Example 5-2. Meanwhile, the discharge capacity retention ratio of the ambient temperature cycle characteristics of Examples 5-2 and 5-12 was higher than that of Comparative example 5-2. The discharge capacity retention ratio of the ambient temperature cycle characteristics of Examples 5-2 and 5-12 was equal to each other. Accordingly, it was confirmed that in order to secure the cycle characteristics and the storage characteristics, the sulfone compound shown in Chemical formula 1 such as the sulfone compound in Chemical formula 2(1) and the sulfone compound in Chemical formula 2(2) was more preferable than the sulfone compound in Chemical formula 11 as a sulfone compound.

Further, the discharge capacity retention ratios of the ambient temperature cycle characteristics and the high temperature storage characteristics of Examples 5-5 to 5-7 was higher than that of Comparative example 5-1, and almost equal to that of Example 5-2. It is needless to say that in this case, the discharge capacity retention ratio of Example 5-6 was higher than that of Comparative example 5-3. In particular, out of Examples 5-5 to 5-7, the discharge capacity retention ratios of the ambient temperature cycle characteristics and the high temperature storage characteristics of Example 5-6 in which the solvent contained FEC were significantly high. Accordingly, it was confirmed that in the secondary battery in which the electrolytic solution contained the sulfone compound shown in Chemical formula 1, even when the composition of the solvent was changed, the cycle characteristics and the storage characteristics were secured. It was also confirmed that in this case, when the solvent contained FEC, higher effects were obtained.

In addition, the discharge capacity retention ratios of the ambient temperature cycle characteristics and the high temperature storage characteristics of Example 5-8 to 5-11 were higher than those of Comparative example 5-1 and Example 5-2. It is needless to say that in this case, the discharge capacity retention ratio of Example 5-11 was higher than that of Comparative example 5-4. In particular, out of Examples 5-8 to 5-11, the discharge capacity retention ratios of the ambient temperature cycle characteristics and the high temperature storage characteristics of Examples 5-9 and 5-10 in which the solvent contained trans-DFEC or cis-DFEC were significantly high. Accordingly, it was confirmed that in the secondary battery in which the electrolytic solution contained the sulfone compound shown in Chemical formula 1, when the solvent contained the cyclic ester carbonate having a halogen as an element shown in Chemical formula 1 or the cyclic ester carbonate having an unsaturated bond, higher effects were obtained. In addition, it was also confirmed that in the secondary battery in which the electrolytic solution contained the sulfone compound shown in Chemical formula 1, when the solvent contained DFEC, still higher effects were obtained.

### Examples 6-1 to 6-3

A procedure was performed in the same manner as that of Examples 4-1 to 4-3, except that the anode active material layer 34B was formed by the procedure described in Examples 5-1 to 5-12.

For the secondary batteries of Examples 6-1 to 6-3, the ambient temperature cycle characteristics and the high temperature storage characteristics were examined. The results shown in Table 6 were obtained. Table 6 also shows the characteristics of Example 5-9.

TABLE 6
Anode active material: Si (sintering method)

| | | | | | | | Discharge capacity | |
|---|---|---|---|---|---|---|---|---|
| | | | | | | | retention ratio (%) | |
| | | | | | | | | High |
| | | | | | Sulfone | | Ambient | temperature |
| | | | | | compound | | temperature cycle | storage |
| | Electrolyte salt | | Solvent | | Type | wt % | characteristics | characteristics |
| Example 5-9 | LiPF₆ | | EC + DEC | Trans- | Chemical | 1 | 82 | 88 |
| | 1.0 mol/kg | | | DFEC | formula | | | |
| Example 6-1 | LiPF₆ | LiBF₄ | | 5 wt % | 2(1) | | 82 | 90 |
| | 0.9 mol/kg | 0.1 mol/kg | | | | | | |
| Example 6-2 | | LiTFSI | | | | | 82 | 89 |
| | | 0.1 mol/kg | | | | | | |
| Example 6-3 | | Chemical | | | | | 82 | 90 |
| | | formula 10(2) | | | | | | |
| | | 0.1 mol/kg | | | | | | |

As shown in Table 6, when comparison was made between Example 5-9 and Examples 6-1 to 6-3, the discharge capacity retention ratios of the ambient temperature cycle characteristics and the high temperature storage characteristics of Examples 6-1 to 6-3 were almost equal to those of Example 5-9 regardless of the type of the added electrolyte salt. Accordingly, it was confirmed that in the secondary battery in which the anode 34 contained silicon (sintering method) as the anode active material and the electrolytic solution contained the sulfone compound shown in Chemical formula 1, the cycle characteristics and the storage characteristics were secured even when the composition of the electrolyte salt was changed.

As evidenced by the foregoing results of Table 1 to Table 6, it was confirmed that when the electrolytic solution contained the sulfone compound shown in Chemical formula 1, the cycle characteristics and the storage characteristics were secured regardless of the material used as an anode active material and the method of forming the anode active material layer 34B. In particular, it was found that higher effects could be obtained when silicon providing a high energy density was used as an anode active material, since thereby the increase rates of the discharge capacity retention ratios of both the ambient temperature cycle characteristics and the high temperature storage characteristics were improved. The reason thereof may be as follows. When silicon providing a high energy density was used as an anode active material, the decomposition reaction of the electrolytic solution in the anode 34 was easily generated than in the case of using a carbon material. Thus, in this case, the decomposition inhibition effects of the electrolytic solution due to the sulfone compound shown in Chemical formula 1 were significantly demonstrated.

The present application is not limited to the aspects described in the foregoing embodiment and the foregoing examples, and various modifications may be made. For example, usage applications of the electrolytic solution of the invention are not limited to the battery, but may include electrochemical devices other than the battery. As other electrochemical devices, for example, a capacitor and the like can be cited.

In the foregoing embodiment and the foregoing examples, the description has been given of the lithium ion secondary battery in which the anode capacity is expressed by the capacity component based on insertion and extraction of lithium, or the lithium metal secondary battery in which the lithium metal is used as an anode active material and the anode capacity is expressed by the capacity component based on precipitation and dissolution of lithium as the battery of the invention. However, the battery of the invention is not limited thereto. The invention can be similarly applied to a secondary battery in which the anode capacity includes the capacity component based on insertion and extraction of lithium and the capacity component based on precipitation and dissolution of lithium, and the anode capacity is expressed by the sum of these capacity components, by setting the charge capacity of the anode material capable of inserting and extracting lithium to a smaller value than that of the charge capacity of the cathode.

Further, in the foregoing embodiment and the foregoing examples, the description has been given of the case using lithium as an electrode reactant. However, as an electrode reactant, other Group 1A element such as sodium (Na) and potassium (K), a Group 2A element such as magnesium and calcium (Ca), or other light metal such as aluminum may be used. In this case, the anode material described in the foregoing embodiment can be used as an anode active material as well.

Further, in the foregoing embodiment or the foregoing examples, the description has been given with the specific examples of the cylindrical or laminated film type secondary battery as a battery structure of the battery of the invention, and with the specific example of the spirally winding structure as a structure of the battery device. However, the battery can be similarly applied to a battery having other structure such as a coin type battery, a button type battery, and a square battery, or a battery in which the battery device has a lamination structure. Further, the battery of the invention can be applied to other batteries such as primary batteries in addition to the secondary batteries.

Further, in the foregoing embodiment and the foregoing examples, regarding the content of the sulfone compound shown in Chemical formula 1 in the electrolytic solution of the invention, the appropriate numerical value range thereof derived from the results of the examples has been described. However, such a description does not totally eliminate the possibility that the content may be out of the foregoing range. That is, the foregoing appropriate range is the range particularly preferable for obtaining the effects of the invention. Therefore, as long as effects of the invention can be obtained, the content may be out of the foregoing range in some degrees.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrolytic solution comprising:
a solvent;
an electrolyte salt; and
a sulfone compound shown in Chemical formula 1. 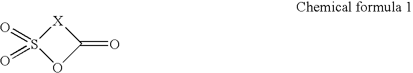
X represents an alkylene group with the carbon number in the range from 2 to 4, an alkenylene group with the carbon number in the range from 2 to 4, a derivative of alkylene group or a derivative of alkenylene group.

2. The electrolytic solution according to claim 1, wherein a content of the sulfone compound is in a range from 0.01 wt % to 5 wt %.

3. The electrolytic solution according to claim 1, wherein the solvent contains at least one selected from the group consisting of chain ester carbonate having a halogen as an element shown in Chemical formula 2 and cyclic ester carbonate having a halogen as an element shown in Chemical formula 3: 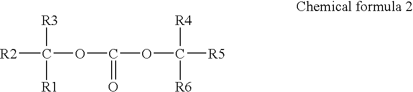
R1 to R6 represent a hydrogen group, a halogen group, an alkyl group, or an alkyl halide group. R1 to R6 may be identical or different. However, at least one of R1 to R6 is the halogen group or the alkyl halide group. 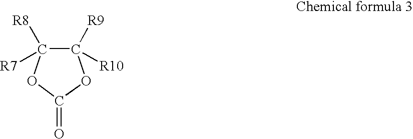
R7 to R10 represent a hydrogen group, a halogen group, an alkyl group, or an alkyl halide group. R7 to R10 are identical or different, where, at least one of R7 to R10 is the halogen group or the alkyl halide group.

4. The electrolytic solution according to claim 3, wherein the cyclic ester carbonate having a halogen as an element includes at least one of 4-fluoro-1,3-dioxolane-2-one and 4,5-difluoro-1,3-dioxolane-2-one.

5. The electrolytic solution according to claim 1, wherein the solvent contains a cyclic ester carbonate having an unsaturated bond.

6. The electrolytic solution according to claim 1, wherein the electrolyte salt contains at least one selected from the group consisting of lithium hexafluorophosphate, lithium tetrafluoroborate, lithium perchlorate, lithium hexafluoroarsenate, and compounds shown in Chemical formulas 4 to 6.
LiN(CₘnF₂ₘ₊₁SO₂)(CₙF₂ₙ₊₁SO₂) Chemical formula 4
m and n represent an integer number of 1 or more. m and n may be identical or different. 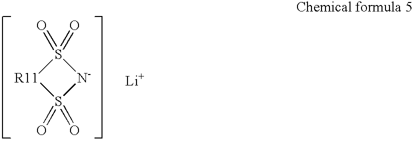
R11 represents a straight chain or branched perfluoro alkylene group with the carbon number in the range from 2 to 4.
LiC(CₚF₂ₚ₊₁SO₂)(C_{q}F_{2q+1}SO₂)(CᵣF₂ᵣ₊₁SO₂) Chemical formula 6
p, q, and r represent an integer number of 1 or more. p, q, and r may be identical or different.

7. A battery comprising:
a cathode;
an anode; and
an electrolytic solution,
wherein the electrolytic solution contains a solvent, an electrolyte salt, and a sulfone compound shown in Chemical formula 7: 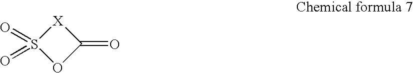
X represents an alkylene group with the carbon number in the range from 2 to 4, an alkenylene group with the carbon number in the range from 2 to 4, a derivative of alkylene group or a derivative of alkenylene group.

8. The battery according to claim 7, wherein a content of the sulfone compound in the electrolytic solution is in a range from 0.01 wt % to 5 wt %.

9. The battery according to claim 7, wherein the solvent contains at least one selected from the group consisting of chain ester carbonate having a halogen as an element shown in Chemical formula 8 and cyclic ester carbonate having a halogen as an element shown in Chemical formula 9: 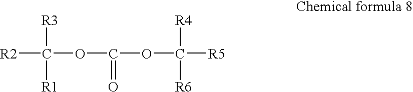
R1 to R6 represent a hydrogen group, a halogen group, an alkyl group, or an alkyl halide group. R1 to R6 are be identical or different, where at least one of R1 to R6 is the halogen group or the alkyl halide group. 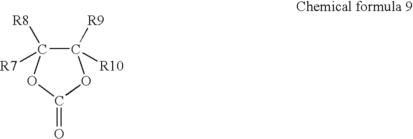
R7 to R10 represent a hydrogen group, a halogen group, an alkyl group, or an alkyl halide group. R7 to R10 are identical or different, where at least one of R7 to R10 is the halogen group or the alkyl halide group.

10. The battery according to claim 9, wherein the cyclic ester carbonate having a halogen as an element includes at least one of 4-fluoro-1,3-dioxolane-2-one and 4,5-difluoro-1,3-dioxolane-2-one.

11. The battery according to claim 7, wherein the solvent contains a cyclic ester carbonate having an unsaturated bond.

12. The battery according to claim 7, wherein the electrolyte salt contains at least one selected from the group consisting of lithium hexafluorophosphate, lithium tetrafluoroborate, lithium perchlorate, lithium hexafluoroarsenate, and compounds shown in Chemical formulas 10 to 12:
LiN(CₘF₂₊₁SO₂)(CₙF₂₊₁SO₂) Chemical formula 10
m and n represent an integer number of 1 or more; m and n are identical or different. 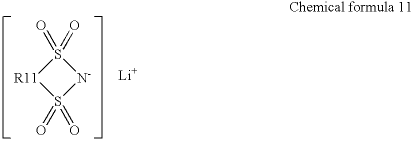
R11 represents a straight chain or branched perfluoro alkylene group with the carbon number in the range from 2 to 4.
LiC(CₚF₂ₚ₊₁SO₂)(C_{q}F_{2q+1}SO₂)(CᵣF₂ᵣ₊₁SO₂) Chemical formula 12
p, q, and r represent an integer number of 1 or more; p, q, and r are identical or different.

13. The battery according to claim 7, wherein the anode contains at least one selected from the group consisting of a carbon material, lithium metal, and a material containing at least one of a metal element and a metalloid element as an element.

14. The battery according to claim 7, wherein the anode contains at least one selected from the group consisting of a simple substance of silicon, an alloy of silicon, a compound of silicon, a simple substance of tin, an alloy of tin, and a compound of tin.

15. The battery according to claim 7, wherein the anode comprises:
an anode current collector; and an anode active material layer provided on the anode current collector, wherein the anode active material layer is formed by at least one method selected from the group consisting of vapor-phase deposition method, liquid phase deposition method, and firing method.
